(19) United States
(12) Patent Application Publication
(10) Pub. No.: US 2025/0335250 A1
(43) Pub. Date: Oct. 30, 2025

(54) SYSTEMS AND METHODS FOR SELECTIVELY EXECUTING USER-GENERATED LOGIC

(71) Applicant: SHOPIFY INC., Ottawa (CA)

(72) Inventors: Joshua Beckman, Chicago, IL (US); Jeffrey Armstrong, Baden (CA); Tien Si Le, Mississauga (CA)

(21) Appl. No.: 18/649,122

(22) Filed: Apr. 29, 2024

(51) Int. Cl. G06F 9/50

(52) U.S. Cl. CPC G06F 9/5027

(57) ABSTRACT

A host may use a computer platform to create an online account or website. Computer-implemented automated workflows may be used to automate tasks related to the online account or website. Workflows may include triggers, conditions, and actions. The conditions and actions of a workflow may be referred to as user-generated logic. The user-generated logic may be executed each time a corresponding trigger occurs, which may create challenges, such as consuming a large amount of resources. A computer-implemented method and system are provided to implement a condition frontloading and evaluation system. The system may allow for the condition(s), or at least a necessary condition of the condition(s), of a workflow to be evaluated earlier on in executing the workflow, and prior to retrieving and executing the code associated with the user-generated logic. The result of the evaluation may determine whether or not the user-generated logic is invoked at all.

### FIELD

The present application relates to workflows for automating computer tasks, and in particular embodiments, to selectively executing the user-generated logic of workflows.

### BACKGROUND

A host user may use a computer platform to create an online account or website. In order to streamline the management of the online account or website, the computer platform may allow for the host to create and customize computer-implemented workflows. The workflows may automate certain processes or tasks. A workflow may generally include a trigger (also known as a trigger event), a condition, and an action. In operation, a workflow may be initiated by the occurrence of its trigger event, and the action may be performed only upon determining that the corresponding condition has been met.

### SUMMARY

While workflows may assist in automating certain tasks, for example, to ensure that the host's online website can operate smoothly, there are technical challenges and issues posed by their implementation.

The condition and the action of a workflow may together be defined as user-generated logic. Implementation of the user-generated logic by executing the associated code requires a substantial amount of computing resources. In the normal course, running the user-generated logic for a given workflow may include at least the following steps. The executable code for the user-generated logic is located and retrieved from memory, and loaded into an execution sandbox or some similar or comparable environment; an Application Programming Interface (API) call is made to a server to retrieve information that may be required to evaluate the condition; the code is run to evaluate the condition, and in cases where the condition is met, implement the action; and the sandbox is torn down and cleaned up.

All of these steps require the use of computer resources. However, in the vast majority of cases, the condition may not be met. Therefore, not only are a substantial amount of resources used to run the executable code of the user-generated logic, in the vast majority of cases, the resources are ultimately wasted.

In addition, a user may create many different workflows to deal with many different situations. For example, the number of workflows tied to a single host user may be on the order of hundreds. Meanwhile, the computer platform may host millions of host users. Therefore, the amount of computer resources that are wasted is markedly high.

Further, a host user may wish to see data related to a specific workflow that was executed. For example, a host may wish to see all executed workflows where the corresponding action(s) were taken, i.e., the condition(s) were met. Accordingly, a history of every executed workflow tied to a host may be stored in the platform for review by the host, and may persist in storage for a defined time. In order to arrive at the run histories of the desired workflows, the host may be required to filter through many irrelevant run histories (where the condition(s) were not met), which may be frustrating for the host. In addition, storing the run history of every executed workflow may take up a substantial amount of space in memory.

In some embodiments, a condition frontloading and evaluation system may be implemented. The system may allow for the condition(s), or at least a necessary condition of the condition(s), of a workflow to be evaluated earlier in executing the workflow, prior to retrieving and executing the code associated with the user-generated logic. The result of the evaluation may determine whether or not the user-generated logic is invoked at all, i.e. whether or not the code associated with the user-generated logic is executed. Specifically, if the condition frontloading and evaluation system determines that the condition may be satisfied, the user-generated logic is implemented by a processor responsible for the implementation by executing the code; if the system determines the condition is not satisfied, the user-generated logic is not implemented by the processor and the associated code is not executed.

Using this system, the challenges and issues listed above can be addressed. For example, the steps described above in relation to implementing the user-generated logic may simply not be executed in the majority of cases, saving a substantial amount of computer resources. Further, only those workflows which were run to completion, i.e., where the condition was met so that the user-generated logic was executed, may be stored as logs. This may improve machine-user interaction, in addition to saving additional computer resources.

In some embodiments, there is provided a computer-implemented method. The method may be responsive to an occurrence of a trigger event associated with initiating a computer-implemented automated workflow, the workflow including user-generated logic that includes a condition and an action to be taken conditioned on whether the condition is satisfied. Prior to execution of the user-generated logic, the method may include a step of obtaining data associated with the trigger event. The method may further include a step of determining, based on the data, whether the condition can be satisfied. The method may further include a step of selectively instructing execution of the user-generated logic based on the determination.

In some embodiments, determining, based on the data, whether the condition can be satisfied may include determining, based on the data, that the condition can be satisfied. In these embodiments, selectively instructing execution of the user-generated logic may include, responsive to determining that the condition can be satisfied, instructing execution of the user-generated logic. In some embodiments, determining, based on the data, whether the condition can be satisfied may include determining, based on the data, that the condition cannot be satisfied. In these embodiments, selectively instructing execution of the user-generated logic may not include execution of the user logic. In some embodiments, determining, based on the data, whether the condition can be satisfied may include determining, based on the data, whether the condition is satisfied.

In some embodiments, the user-generated logic may execute in a different context than a context in which the determination as to whether the condition can be satisfied is made.

In some embodiments, instructing execution of the user-generated logic may include instructing execution of code corresponding to the user-generated logic.

In some embodiments, the method may further include a step of: prior to initiating the workflow in response to the occurrence of the trigger event, receiving an indication of the computer-implemented automated workflow.

In some embodiments, the method may further include a step of obtaining a value and a function from memory. The value and the function may be associated with the condition, and the function and the value together may be used to determine whether the condition can be satisfied. In some embodiments, the function may be determined based on the condition.

In some embodiments, the method may further include a step of transmitting, to a user device, web content for display on a graphical user interface of the user device. The web content may include the workflow created by a user of the user device. The method may further include a step of transmitting, to the user device, instructions to update the graphical user interface to permit the user to configure the function and the value. The method may further include a step of receiving, from the user device, an input via the graphical user interface associated with the user having configured the function and the value. The method may further include a step of storing the function and the value in the memory in association with the workflow, responsive to receiving the input.

In some embodiments, obtaining the data may include receiving a Hypertext Transfer Protocol (HTTP) request. The HTTP request may include the data. In some embodiments, the HTTP request may be a webhook.

In some embodiments, a workflow identifier may be assigned to the workflow, a user identifier may be associated with the workflow, a trigger event identifier may be associated with the trigger event, and the function and the value may be stored in a database in the memory. In some embodiments, determining, based on the data, whether the condition can be satisfied may include using a first portion of the data, and may further include a step of querying the database using a second portion of the data associated with the trigger event to locate the workflow identifier. The second portion of the data may include the trigger event identifier and the user identifier. In some embodiments, determining, based on the data, whether the condition can be satisfied may further include a step of using the workflow identifier to retrieve the function and the value. In some embodiments, determining, based on the data, whether the condition can be satisfied may further include a step of determining whether the first portion of the data is within a criteria defined by the function and the value to determine whether the condition can be satisfied.

In some embodiments, the value may be a first hash value which includes a hash of: (i) another value associated with the condition and (ii) an identifier associated with the trigger event. In some embodiments, determining, based on the data, whether the condition can be satisfied may further include a step of obtaining a second hash value by hashing (i) the first portion of the data and (ii) an associated identifier of the trigger event in the data, and determining whether the second hash value is equal to the first hash value to determine whether the condition can be satisfied.

A system is also disclosed that is configured to perform the methods disclosed herein. For example, the system may include at least one processor to directly perform (or instruct the system to perform) the method steps. In some embodiments, the system includes at least one processor and a memory storing processor-executable instructions that, when executed, cause the at least one processor to perform any of the methods described herein.

In another embodiment, there is provided a computer readable medium having stored thereon computer-executable instructions that, when executed by a computer, cause the computer to perform operations of the methods disclosed herein. The computer readable medium may be non-transitory.

### BRIEF DESCRIPTION OF THE DRAWINGS

Embodiments will be described, by way of example only, with reference to the accompanying figures wherein:

FIG. 1 is a block diagram illustrating a system for selectively executing user-generated logic, according to some embodiments;

FIG. 2 illustrates a computer-implemented automated workflow, according to one embodiment;

FIG. 3 illustrates a computer-implemented automated workflow configured with a function and a value for selectively executing user-generated logic, according to some embodiments;

FIG. 4 illustrates a webhook payload and databases for use with respect to selectively executing user-generated logic of FIG. 3, according to some embodiments;

FIG. 5 illustrates another computer-implemented automated workflow configured with a function and a value for selectively executing user-generated logic, according to some embodiments;

FIG. 6 illustrates another computer-implemented automated workflow configured with a function and a value for selectively executing user-generated logic, according to some embodiments;

FIG. 7 illustrates webhook payloads and a database for use with respect to selectively executing user-generated logic of FIGS. 5 and 6, according to some embodiments; and

FIG. 8 illustrates a computer-implemented method, according to some embodiments.

### DETAILED DESCRIPTION

For illustrative purposes, specific embodiments will now be explained in greater detail below in conjunction with the figures.

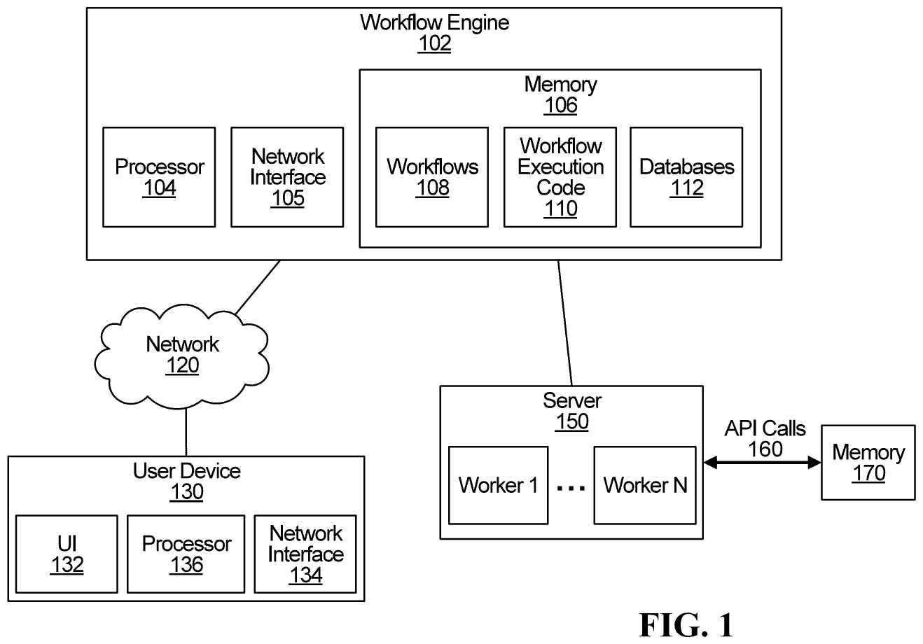

FIG. 1 is a block diagram illustrating a system for selectively executing user-generated logic of computer-implemented automated workflows, according to some embodiments. The system includes a workflow engine 102, a network 120, a user device 130, a server 150, and a memory 170.

The workflow engine 102 may be part of a computer platform. The computer platform may be one that enables a host user to create an online account or website, using a user device such as user device 130. The computer platform may also enable host users to create automated workflows to automate tasks related to the online account or website.

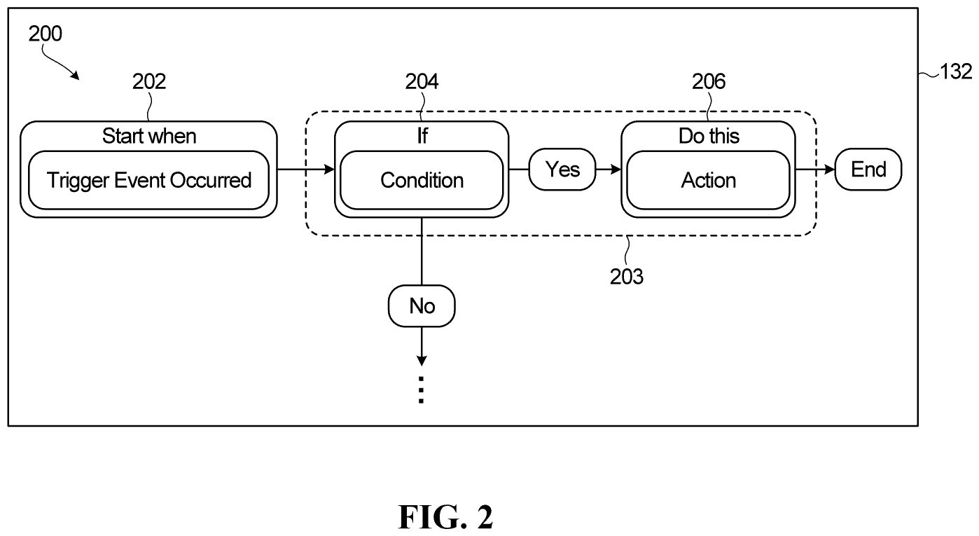

A general structure of an example computer-implemented automated workflow 200 is illustrated in FIG. 2. Referring briefly to FIG. 2, the workflow 200 may include various steps to be executed by the computer platform. The steps may include a trigger 202, a condition 204, and an action 206. A trigger event, e.g., trigger 202, may generally be defined as a change that occurs in relation to the online account or website, and which causes the workflow, e.g., workflow 200, to begin executing. A condition, e.g., condition 204, may generally be defined as a limitation that must be met in order for a corresponding action to be executed. A condition may generally be represented by one or more true or false statements, and may contain one or more Boolean operators, such as AND, OR, NOT, etc. Depending upon whether the condition is met (e.g., whether the condition is “true”), the next step of the workflow is executed, which may be the execution of a corresponding action, another condition, or termination of the workflow. An action, e.g., action 206, may generally be defined as a step that is executed in response to a corresponding condition being met. Although only one condition 204 and one action 206 is illustrated in FIG. 2, a single workflow may include multiple conditions associated with a trigger, and/or for each condition, multiple actions. The multiple conditions may be evaluated in parallel and/or in sequence, and the multiple actions may be executed in parallel and/or in sequence. The condition and the action of a workflow may together be defined as user-generated logic, e.g., user-generated logic 203.

Returning to FIG. 1, as illustrated, the workflow engine 102 includes a processor 104, a network interface 105, and memory 106. In some embodiments the processor 104, network interface 105, and memory 106 may be located outside of the workflow engine 102.

The processor 104 directly performs, or instructs the workflow engine 102 to perform, the operations described herein as being performed by the workflow engine 102, such as providing content for display on a user interface of a user device such as user device 130, building and storing workflows designed by a host user, or instructing execution of workflows in response to the occurrence of a trigger event. The processor 104 may be implemented by one or more general purpose processors that execute instructions stored in a memory (e.g. in memory 106) or stored in another computer-readable medium. The instructions, when executed, cause the processor 104 to directly perform, or instruct the workflow engine 102 to perform the operations described herein. Alternatively, the processor 104 may be implemented using dedicated circuitry, such as a programmed FPGA, a GPU, or an ASIC.

The network interface 105 is provided for communicating over a network, e.g. to communicate with user device 130. The network interface 105 may be implemented as a network interface card (NIC), and/or a computer port (e.g. a physical outlet to which a plug or cable connects), and/or a network socket, etc., depending upon the implementation.

The memory 106 may store instructions and data used or generated by the workflow engine 102. For example, the memory 106 may store software instructions or modules configured to implement some or all of the functionality and/or embodiments described herein and that are executed by the processor 104. The memory 106 may store currently existing workflows 108 that are designed by one or more host users. The memory 106 may also store workflow execution code 110, used by the processor 104 to execute the stored workflows 108. The memory 106 may also include databases 112, which include databases containing information used to determine whether or not to execute the user-generated logic of a workflow, in accordance with the present application, as described herein.

The network 120 may be a computer network implementing wired and/or wireless connections between different devices, including the workflow engine 102 and the user device 130. The network 120 may implement any communication protocol known in the art. Non-limiting examples of network 120 include a local area network (LAN), a wireless LAN, an internet protocol (IP) network, and a cellular network.

The user device 130 includes a user interface (UI) 132, a network interface 134, and a processor 136. Although only one user device 130 is illustrated in FIG. 1 for simplicity, a plurality of user devices may communicate with the workflow engine 102 over network 120.

The processor 136 of user device 130 directly performs or instructs all of the operations performed by the user device 130. Examples of these operations include sending requests for web content to the workflow engine 102, receiving the requested web content, and instructing the UI 132 of the user device 130 to display the web content. The processor 136 may be implemented by one or more processors that execute instructions stored in the memory 434 or in another computer readable medium. Alternatively, some or all of the processor 136 may be implemented using dedicated circuitry, such as an ASIC, a GPU, or a programmed FPGA.

The network interface 134 is provided for communicating over the network 120. The structure of the network interface 134 will depend on how user device 130 interfaces with the network 120. For example, if user device 130 is a wireless device such as a mobile phone, headset or tablet, then the network interface 134 may include a transmitter/receiver with an antenna to send and receive wireless transmissions to/from the network 120. If the user device is a personal computer connected to the network with a network cable, then the network interface 134 may include, for example, a NIC, a computer port, and/or a network socket. The user interface 132 may be implemented as a display screen (which may be a touch screen), and/or a keyboard, and/or a mouse, etc., depending upon the implementation.

Conventionally, each time a workflow is initiated, i.e., the trigger event occurs, the corresponding user-generated logic is run. More accurately, the machine-executable code associated with the user-generated logic, which may be stored in the workflow execution code 110 of memory 106, is run. Running the user-generated logic requires a substantial amount of computing resources, as implementation of the user-generated logic may require at least the following steps.

The processor 104 may first locate and retrieve the machine-executable code for the user-generated logic from memory 106, and push the execution to a worker (e.g., worker 1, worker 2, . . . worker N), which may exist externally to the workflow engine 102, e.g., in an external server 150. In some instances, a worker may be spun up for the task of executing the machine-executable code for the workflow. The worker may load the executable code into an execution sandbox or a similar environment. As illustrated, one or more API calls 160 may be made to a memory 170 to retrieve information required to evaluate the condition(s) of the workflow. The executable code may then be run. Once the run is terminated (e.g., due to early termination after a condition is not met, or upon running the code to completion), the worker may tear down and clean up the execution sandbox. Further, the worker may generate and send a log or report back to the workflow engine 102 to be stored in memory 106 (not shown) for a period of time, the log or report having details about the executed code. The worker may subsequently be spun down.

All of these aforementioned steps that are required for running the machine-executable code associated with user-generated logic may be resource intensive. In addition, it is inefficient. In most cases, the condition(s) may not be met so that a corresponding action need not be implemented. Thus, in the vast majority of cases, the resources consumed to run the user-generated logic are ultimately wasted.

For example, a host user may create a website using the computer platform. The computer platform may enable the host user to set parameters to restrict access to content posted on the website by others. For example, other users may be able to gain access to content posted on the website only by creating online membership or subscriber accounts. The host user may create workflows to automate tasks related to the website. In an example scenario, the host user may be concerned about fraudulent activity, where entities with ill intent attempt to hack into a user's account to access sensitive information about the user or access certain member-only content on the host user's website. In an effort to prevent such entities from being successful, the host user may build a workflow that is triggered upon a failed attempt at logging into a membership or subscriber user account. Thus, the trigger event may be set by the host user as a failed login attempt.

Most, if not all, entities attempting to fraudulently gain access to a user account use a virtual private network (VPN) to mask their true internet protocol (IP) address and replace it with a different IP address. Since many VPN providers share IP addresses, many of these shared IP addresses may be known. For example, organizations may publish a list of “blacklisted” or suspicious IP addresses. Thus, the condition for the workflow set by the host user may be to confirm that the IP address listed as belonging to the entity that made the failed login attempt matches an IP address in a suspicious IP address list. The corresponding action to this condition may be to configure multi-factor authentication (MFA) for a defined period of time, e.g., for one hour following the failed login attempt, which requests additional verification from the entity when trying to log into the account in question. This may decrease the likelihood of a successful cyber attack.

The workflow created by the host user would be stored in memory 106. Subsequently, in conventional operation, any time an unsuccessful login attempt is communicated to the workflow 102 as having been made, the workflow would be initiated, and the user-generated logic would be executed. This would require all of the resource-intensive steps mentioned above. For example, the workflow engine 102 would push the execution of the machine-executable code associated with the user-generated logic to an external worker, the worker would load the code into an execution sandbox, and make one or more API calls 160 to external memory 170 to collect information that may be relevant or required for execution of the code, etc. API calls 160 could be made, for example, to request data about the user account trying to be accessed, or relevant information to be used by the processor 104 if the condition was met and MFA was required, such as a phone number or email address associated with the user account. In evaluating the condition, if the IP address matches an IP address in the suspicious IP address list, the condition would be met and code would continue to be executed to implement the action, i.e., configured the MFA. If the condition would not be met, i.e., the IP address of the entity does not match, the run would be terminated early and the action would not be implemented. Regardless of the result, i.e., regardless of whether the condition is met or not, the worker would tear down and clean up the execution sandbox, and send a log back to the workflow engine 102 to be stored in memory 106.

Of course, in the vast majority of cases, a failed login attempt would be innocent in nature. For example, a failed login attempt is much more likely to be caused by the rightful user making a typo in inputting their account information, or simply forgetting their account information, than by a fraudulent entity. For these cases, the condition would fail to be met, since the IP address of the entity would not match any of the IP addresses in the suspicious IP address list, and the action would not be implemented. Therefore, for most cases the execution of the user-generated logic would ultimately lead to nothing more than wasted resources.

Further, there may be other challenges or issues associated with running the user-generated logic.

For example, there may be an API rate limit associated with a host user's online account or website. A host user may create many, e.g., hundreds or thousands, of workflows, and each workflow may require at least one API call 160 to evaluate the condition of the user-generated logic. When many workflows are being executed at once, for example because the trigger events of many of the workflows correspond to changes that happens frequently in relation to the host user's website, and/or there are many workflows that stem from one trigger event, etc., many API calls must also be executed at once to retrieve data. In addition to being burdensome from a resource consumption perspective, reaching or exceeding the API rate limit may cause errors and delays in executing the workflows, as will be evident to a person skilled in the art. Further, it is noted that the computer platform, and thus the workflow engine 102, may support millions of host users, each with their own online account(s) or website(s). Therefore, even if the API rate limit for a single host user account or website is not reached, when the user-generated logic of many workflows from different online accounts or websites are being executed at once, there may be an API throttling issue, which may in turn also lead to errors and delays in executing the workflows, as will be evident to a person skilled in the art.

Additionally, the logs created and stored in memory 106 relating to the execution of user-generated logic of workflows may be made available to a host user to view using the user device 130. This may be useful for a host user that wants to see data related to certain executed workflows. For example, a host user may wish to see details of executed workflows where the corresponding action(s) were taken, i.e., the condition(s) were met. In the example scenario discussed above, the host user may wish to see information regarding the workflows where the IP address used to make a failed login attempt matched a suspicious IP address and MFA was enabled. Since a log is created for each execution of the user-generated logic, the host user may be required to look through many irrelevant run logs (i.e., where the IP address associated with the failed login attempt did not match a suspicious IP address so that the condition was not met) to arrive at the log(s) they wish to see. This may be frustrating for the host user, who may have to sift through thousands of irrelevant run logs. Moreover, the storage of the logs that relate to every single instance of user-generated logic execution may take up a substantial amount of space in memory 106.

It would thus be beneficial to have a system which can address these issues.

The present application introduces a condition frontloading and evaluation system. The system may allow for the condition(s), or at least a necessary condition of the condition(s), of a workflow to be evaluated earlier in executing the workflow, prior to retrieving and executing the code associated with the user-generated logic. The result of the evaluation may lead to selectively instructing execution of the user-generated logic of the workflow, i.e., the result will determine whether the machine-executable code associated with the user-generated logic is executed at all. This system addresses the challenges and issues described previously, as will be explained in greater detail below.

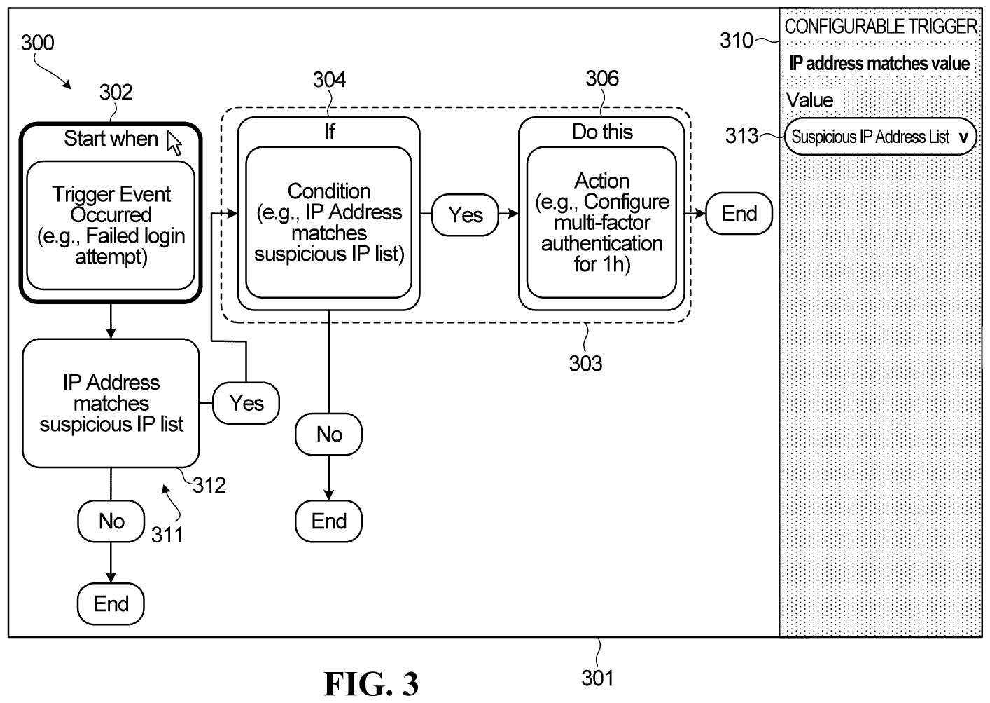

FIG. 3 illustrates a UI 301 for creating and editing workflows configured with condition frontloading and evaluation (hereinafter referred to as “condition-frontloaded workflows”), according to some embodiments. The UI 301 may be implemented on UI 132 (FIG. 1). The UI 301 utilizes simple block diagrams and drag-and-drop mechanisms to assist host users to build condition-frontloaded workflows without the need to write or edit code directly. Although not illustrated, the UI 301 may additionally include graphical user interface elements that allow the host user to modify or save a condition-frontloaded workflow, activate or deactivate a condition-frontloaded workflow, create a new condition-frontloaded workflow, and/or view other saved condition-frontloaded workflows created by the host user.

To enable host users to build condition-frontloaded workflows, the processor 104 of the workflow engine 102 may receive instructions from, and send instructions to, the host user device 130. The UI 301 illustrates an example condition-frontloaded workflow 300. The condition-frontloaded workflow 300 includes a trigger 302, a condition 304, and an action 306, with the condition 304 and the action 306 together defining user-generated logic 303. The condition-frontloaded workflow 300 of FIG. 3 describes an example trigger 302, which is a failed login attempt; an example condition 304, which is that the IP address associated with the failed login attempt matches an IP address in a suspicious IP address list; and an example action 306, which is to configure MFA for the following hour. The condition 304 and the action 306 together define user-generated logic 303.

In addition, the condition-frontloaded workflow 300 includes a condition evaluation mechanism 311. Unlike workflow 200, for which the user-generated logic 203 is executed straightaway upon the occurrence of the trigger event 202, upon occurrence of the trigger 302, the next step in executing the condition-frontloaded workflow 300 involves the condition evaluation mechanism 311.

The purpose of the condition evaluation mechanism 311 is to evaluate a precondition 312 prior to execution of the user-generated logic of a condition-frontloaded workflow. Indeed, the condition evaluation mechanism 312 may allow the processor 104 to determine whether the user-generated logic 303, the constant execution of which is associated with the disadvantages and challenges explained previously, needs to be invoked at all. The precondition 312 may be the same as the condition 304, or alternatively may be a necessary condition of condition 304. Machine-executable code associated with the condition evaluation mechanism 311, may be stored in the workflow engine 102, e.g., as part of the workflow execution code 110 in memory 106.

In some embodiments, the condition evaluation mechanism 311 may be represented by an evaluation function comprising a function and a value. The function may generally be defined as a computational operation that evaluates to true or false, and the value may generally be defined as a component (e.g., a value, a threshold, a database query result, etc.) that is compared against an input to the evaluation function to determine whether the condition 304 is, or can be, satisfied.

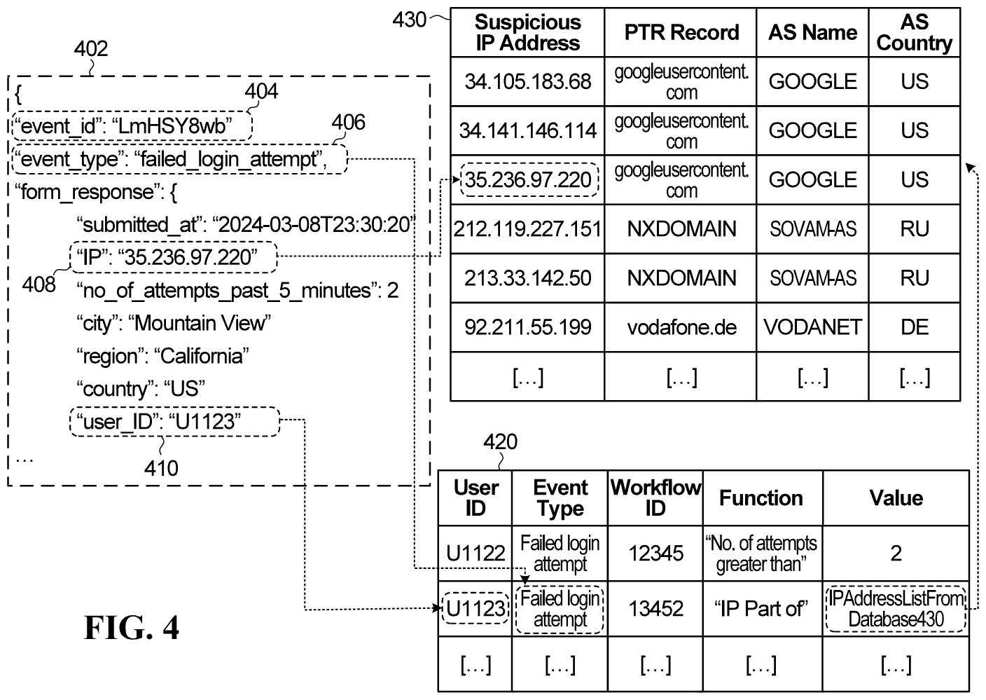

FIG. 3 illustrates an example of an embodiment where the precondition 312 is the same as the condition 304, i.e., where both the example precondition 312 and the example condition 304 is that the IP address associated with the trigger event 302 matches an IP address on a suspicious IP address list. In conjunction with FIG. 4, an embodiment of implementing the condition evaluation mechanism 311 will be explained.

The occurrence of a trigger event associated with a workflow (e.g., workflow 200, workflow 300) may be communicated to the workflow engine 102 of the computer platform via an HTTP request. In some embodiments, this HTTP request may be a webhook. A webhook may be defined as a specific type of HTTP request, that is triggered by an event in a source system and sent to a destination system, along with a payload of data. Unlike an API call (e.g., API call 160) which involves a request for data and requires waiting for an API response to obtain the requested-for data, a webhook delivers certain data to the destination system so that the data is immediately available to the destination system.

FIG. 4 illustrates an example webhook payload 402 corresponding to the example condition-frontloaded workflow 300. The webhook containing webhook payload 402 is received by the workflow engine 102 upon the occurrence of a failed login attempt, i.e., the trigger event, in relation to a member account for the host user's website.

The webhook payload 402 may be in standard JavaScript Object Notation (JSON) format with information represented by key-value pairs, including at least an event identifier (ID) element 404, an event type ID element 406, and a nested data object that includes information related to the trigger event that initiated the webhook. For example, the nested data object may include the time at which the failed login attempt occurred, an IP address element 408 associated with the entity responsible for the failed login attempt, and a host user ID element 410. In the illustrated example, the event type 406 is “failed_login_attempt”, the IP address 408 associated with the event type 306 is “35.236.97.220”, and the host user ID 410 is “U1123”. This means that the event type 406 which initiated the webhook is a failed login attempt, the IP address 408 associated with the event type 306 is 35.236.97.220, and the user ID 410 of the host user who built the condition-frontloaded workflow 300 (and whose website is trying to be accessed) is known to the workflow engine 102 as “U1123”.

Databases 112 of the workflow engine 102 may include one or more databases required to evaluate the precondition of a condition-frontloaded workflow. For example, databases 112 may include an event filters database 420 (“database 420”) and a database 430 for use in evaluating the precondition 312. Database 420 may be a database table that allows the processor 104 of workflow engine 102 to identify, based on data included in the webhook payload 402, any relevant workflows, and for any identified relevant workflow, whether there is an associated condition evaluation mechanism 311 (i.e., a precondition 312 that is represented by and can be evaluated using a function and a value). For example, database 420 is shown to include columns including “User ID”, “Event Type”, “Workflow ID”, “Function” and “Value”, and may contain data regarding every workflow (e.g., workflow 200 or condition-frontloaded workflow 300) relating to every host user of the computer platform. For example, FIG. 4 shows that the host user with user ID U1123 (“host user U1123”) has a workflow with a workflow ID of 13452, that is initiated by a trigger event type “failed login attempt”. Workflow ID 13452 is in turn associated with a function element, “IP part of”, and a value element, “IP AddressListFromDatabase430” that form an evaluation function and represent the precondition 312 of the condition evaluation mechanism 311. The evaluation function thus determines whether an IP address in question matches an IP address in an IP address list in the database 430. Workflow ID 13452 corresponds to the example condition-frontloaded workflow 300 of FIG. 3.

Database 430 may be a database table including a list of suspicious IP addresses. For example, the listed IP addresses may be those that are associated with a VPN connection, or known to have a link with malicious activity (e.g., was reported in connection with a cyber attack).

When the trigger 302 occurs such that the condition-frontloaded workflow 300 is initiated, machine-executable code associated with the condition evaluation mechanism 311 is executed by the workflow engine 102, to evaluate the precondition 312. To evaluate the precondition 312, the workflow engine 102 identifies relevant data (“trigger data”) from the received webhook payload 402. In some embodiments, the trigger data may be the event type ID element 406 and the host user ID element 410. Using the trigger data, the workflow engine 102 queries database 420 to determine whether there are any workflows associated with the user ID 408. For example, as shown in FIG. 4, the event type ID element 406 of “failed login attempt” and the host user ID element 410 of “U1123” contained in webhook payload 402 correspond to a workflow ID 13452. The workflow engine 102 further determines whether there is a condition evaluation mechanism, represented by an evaluation function comprising a function and a value, associated with any identified workflow. FIG. 4 shows that the identified workflow with workflow ID 13452 is indeed associated with an evaluation function with entries in the “Function” and “Value” columns. As shown, the evaluation function requires the workflow engine 102 to query database 430 to determine if the IP address element 408 of 35.236.97.220 matches an IP address listed in database 430. As shown for the example illustrated in FIG. 4, the IP address element 408 is determined to match an IP address in database 430. The precondition 312 is thus satisfied. Accordingly, as dictated by the structure of the condition-frontloaded workflow 300, the workflow engine 102 moves on to the next step of executing the user-generated logic 303.

Although FIG. 4 describes an example where the precondition 312 is satisfied (i.e., evaluates to true), it is much more likely, as explained above, that the precondition 312 will not be satisfied (i.e., evaluates to false). In such cases, e.g., where the IP address received in the webhook payload 402 does not match an IP address in database 430, the condition 304 also cannot be satisfied as a fact. The workflow engine 102 thus terminates at the condition evaluation mechanism 311. Consequently, the user-generated logic 303 of the condition-frontloaded workflow 300 is not invoked at all.

In this way, the workflow engine 102 is able to selectively instruct the execution of the user-generated logic 303, based on the results of evaluating the precondition 312 of the condition-frontloaded workflow 300.

This provides an advantage with respect to resource consumption, as execution of the condition evaluation mechanism 311 uses fewer resources than execution of the user-generated logic 303. In particular, the steps described hereinbefore that the workflow engine 102 was required to perform, e.g., spinning up a worker externally, pushing execution to the worker, making an API call 160 to an external memory 170, are no longer necessary in cases where the precondition 312 is not satisfied. For instance, instead of needing to rely on API calls 160, implementation of the condition evaluation mechanism 311 to evaluate the precondition 312 may only require data that is locally accessible, i.e., data in the webhook payload 402, such as event type ID element 406, IP address element 408 and host user ID element 410. The implementation of the condition evaluation mechanism 311 may be conducted at the workflow engine 102 without much resource consumption, when compared with implementation of user-generated logic that was typically done when executing workflows (e.g., workflow 200). The execution of the condition evaluation mechanism 311 is therefore carried out in a much more resource-efficient context than the context in which user-generated logic of a workflow is executed.

Counterintuitively, this means that for that small fraction of cases when the precondition 312 is satisfied and the user-generated logic 303 is executed, there are more resources being used than a case where only the user-generated logic is executed. This is due to resources being initially consumed to execute the condition evaluation mechanism 311, and then additionally being consumed to execute the user-generated logic 303. For example, the likelihood of the precondition 312 being met may be 0.001% so that one out of 1000 cases of failed login attempts relating to the host user U1123's website represent a malicious attack. However, 999 executions of the condition evaluation mechanism 311 plus one execution of the condition evaluation mechanism 311 in addition to the user-generated logic 303 still consumes far fewer resources than 1000 executions of the user-generated logic 303. Therefore, even though a single instance where both the evaluation mechanism 311 and the user-generated logic 303 is executed (due to the precondition 312 being satisfied) may consume more computer resources than an instance where only the user-generated logic 303 is executed, the efficiency of resource usage achieved by implementation of the condition evaluation mechanism 311 is nevertheless greatly increased as compared to a convention workflow design (e.g., workflow 200).

The condition evaluation mechanism 311 may be configured manually by the host user, or automatically, e.g., by the workflow engine 102, based on the trigger 302, or the trigger 302 and the condition 304. For example, in some embodiments, the host user may manually configure the condition evaluation mechanism 311 for the condition-frontloaded workflow 300, for example using GUI elements provided in the UI 301, such as a sidebar 310. As illustrated, FIG. 3 shows an embodiment where the host user is able to use elements such as the sidebar 310 and a menu 313 to configure the precondition 312 to be that the IP address used for the failed login attempt matches an IP address in the suspicious IP address list. In some embodiments, the workflow engine 102 may communicate to a host user that based on the trigger 302, or the trigger 302 and the condition 304 set by the host user for a workflow, a condition evaluation mechanism 311 is configurable. For example, the workflow engine 102 may recognize that the trigger 302 as set by the host user is such that a condition evaluation mechanism can be configured with one of a defined set of preconditions, and may present the sidebar 310 to the host user to request that the host user configure the condition evaluation mechanism 311 and select a precondition 312. Configuring the condition evaluation mechanism 311 may include configuring a function and a corresponding value for the condition-frontloaded workflow 300. Upon configuring the function and the corresponding values, the function and the value may be stored in memory 106 (e.g., in a database in databases 112) in association with the condition-frontloaded workflow 300.

In some embodiments, the workflow engine 102 may be aware that the trigger 302 is one that is configurable with a condition evaluation mechanism 312 as a result of a developer of the computer platform having identified the trigger 302 as such. In other embodiments, the workflow engine 102 may ingest the structure or schema of the webhook payload, to determine that the trigger 302 is one that is configurable with a condition evaluation mechanism 312.

Although not shown in database 420, the host user U1123 may have more workflows, each with their own unique workflow ID. Some of the workflows may have corresponding function and value elements, and some of the workflows may not. Indeed, in some embodiments, a workflow built by a host user (e.g., host user U1123) may not be configurable with a condition evaluation mechanism 311.

In some embodiments, the precondition of a condition-frontloaded workflow may be a necessary condition, as opposed to being the same as the condition of the condition-frontloaded workflow. A necessary condition may be defined as a condition that must be occur for an event to occur. In the context of the present application, a necessary condition may be a condition that must evaluate to true if the condition of the condition-frontloaded workflow is to have any chance of being satisfied. In other words, if the necessary condition evaluates to false, the condition(s) of the condition-frontloaded workflow will always also evaluate to false.

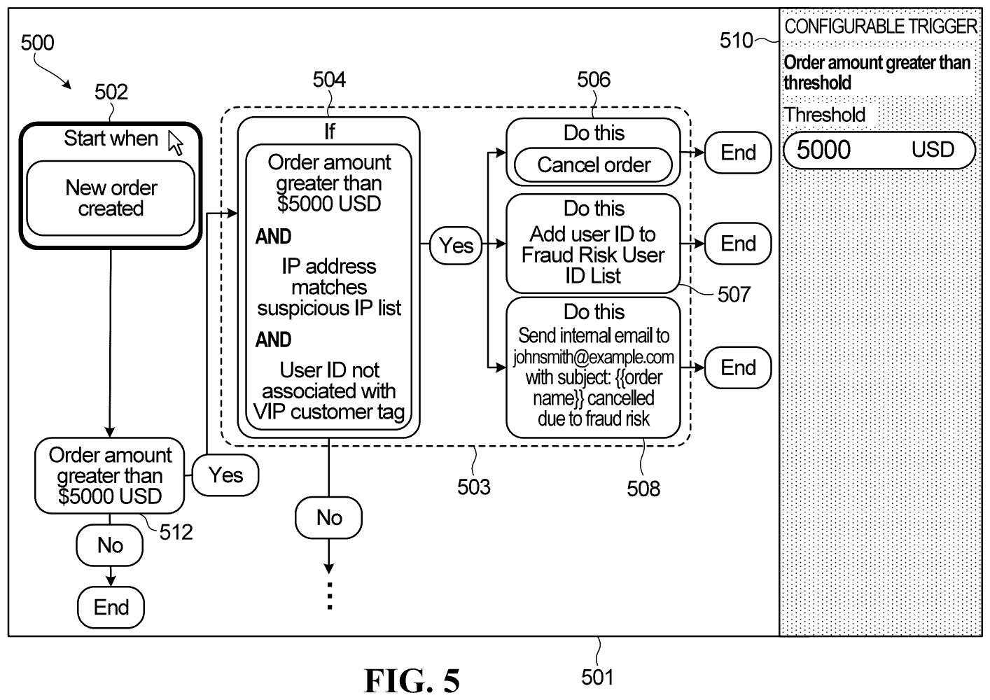

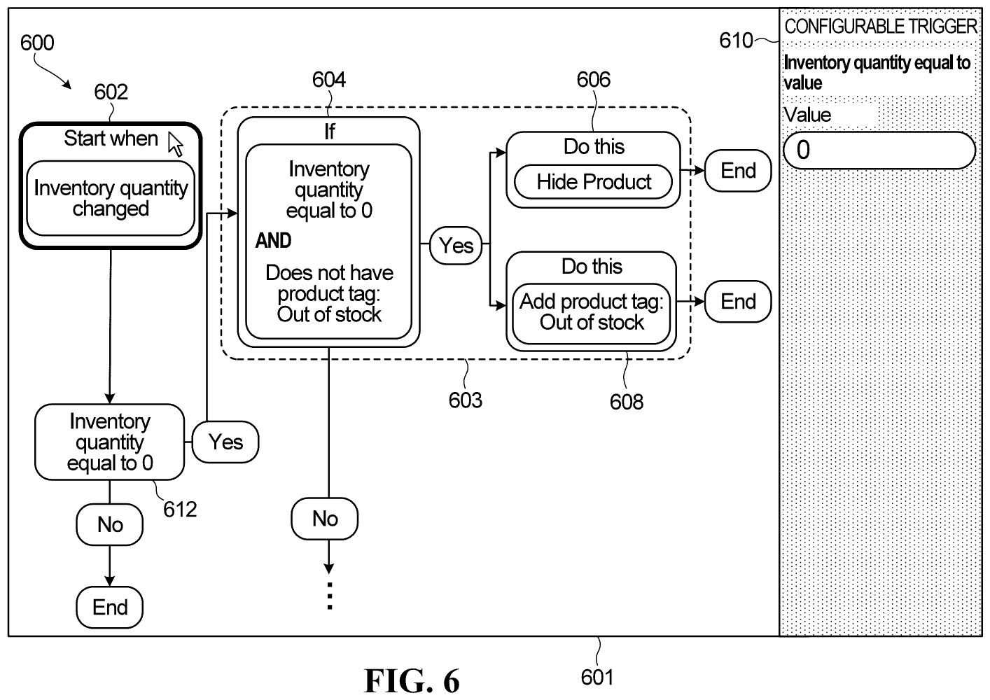

FIGS. 5 and 6 illustrate user interfaces 501, 601, for creating and editing condition-frontloaded workflows 500 and 600, according to some embodiments. The condition-frontloaded workflows 500 and 600 may be created by a host user who is a merchant of one or more online stores, with a user device, e.g., user device 130. User interfaces 501, 601 may be implemented on UI 132 (FIG. 1).

The condition-frontloaded workflow 500 is initiated upon the occurrence of trigger 502, which is that a new order has been created in relation to one or more of the merchant user's online stores. The condition 504 includes statements connected by an AND operator. Specifically, the condition 504 requires that the order amount of the newly created order is greater than $5000 USD, the IP address matches an IP address on a suspicious IP address list, and a customer user ID is not associated with a VIP customer tag, in order to be satisfied. The actions 506, 507, 508 to be implemented if the condition 504 is satisfied are to cancel the newly created order, add the customer user ID to a fraud risk user ID list, and send internal communications to a specified recipient that the order was cancelled due to fraud risk. The condition 504 and the actions 506, 507, 508 together define user-generated logic 503.

The condition-frontloaded workflow 600 is initiated upon the occurrence of trigger 602, which is that the inventory of a product sold online by the merchant user has changed. The condition 604 includes statements connected by an AND operator. Specifically, the condition 604 requires that the inventory quantity of the product is at 0, and product does not have an “out of stock” product tag associated with it, in order to be satisfied. The actions 606, 608 to be implemented if the condition 604 is satisfied are to hide the product from the merchant user's online store(s), and add the product tag, “out of stock” for the product. The condition 604 and the actions 606, 608 together define user-generated logic 603.

Each of the condition-frontloaded workflows 500, 600 are shown to be configured with a respective condition evaluation mechanism. In FIG. 5, the condition evaluation mechanism includes a precondition 512, and in FIG. 6, condition evaluation mechanism includes a precondition 612. Each respective precondition 512, 612, evaluated as part of the respective condition evaluation mechanism is a necessary condition of the respective condition 504, 604. For condition-frontloaded workflow 500, the precondition 512 is that the order amount is greater than $5000 USD. For condition-frontloaded workflow 600, the precondition 612 is that the inventory quantity is equal to zero. Preconditions 512, 612 are necessary conditions of the conditions 504, 604. In other words, while satisfying the precondition 512 or 612 does not automatically mean that the respective condition 504 or 604 is also satisfied, the failure to satisfy the precondition 512 or 612 necessarily means that the respective condition 504 or 604 also cannot be satisfied.

There may be various advantages from a resource efficiency perspective, of using a necessary precondition (e.g., precondition 512, 612) in the condition evaluation mechanism, as opposed to a precondition that is equal to the condition (“equal condition”) of the condition-frontloaded workflow.

For example, in some embodiments, there may be many conditions in a workflow, e.g., many more than what is shown for condition-frontloaded workflows 500, 600 in FIGS. 5 and 6. While using a necessary precondition instead of an equal precondition may increase the likelihood that the precondition is satisfied so that the user-generated logic 503 is required to be implemented more often, setting a statement that is still quite unlikely to be satisfied as the necessary precondition, may minimize the likelihood. For example, in FIG. 5, of the various components of the condition 504, the components of a new order being of an amount greater than $5000 or an IP address matching a suspicious IP address may be less likely to be satisfied than the component of the customer user ID not being associated with a VIP customer tag. One of the former two components may thus be set as the precondition 512, as shown.

As another example, the evaluation of one or more components of a condition may require data that is not available in the HTTP request (e.g., webhook) that communicates the occurrence of a trigger to the workflow engine 102. For example, with reference to FIG. 6, the payload of the webhook sent to the workflow engine 102 upon an inventory quantity change of a product may include the current inventory number of the product, but not include data on whether the product is currently tagged with an “out of stock” tag. Accordingly, in order to evaluate the condition 604, an API call to an external server may be necessary to retrieve more information about the tag status of the product. In such cases, a component of the condition which is able to be evaluated using only the data from the HTTP request and database 112 of the workflow engine 102 may be more resource efficient and therefore chosen to be the precondition 612.

As described earlier with respect to FIG. 3, the condition evaluation mechanisms as illustrated in FIGS. 5 and 6 may also be configured manually by the host user, or automatically, e.g., by the workflow engine 102, based on the trigger 502, 602 or both the trigger 502, 602 and the condition 504, 604. For example, in some embodiments, the host user may manually configure the condition evaluation mechanism for the condition-frontloaded workflow 500, 600, by using GUI elements provided in the UI 501, 601 such as a sidebar 510, 610. In some embodiments, the workflow engine 102 may communicate to the host user that based on the trigger 502, 602 or both the trigger 502, 602 and the condition 504, 604 set by the host user, a condition evaluation mechanism is configurable. For example, the workflow engine 102 may recognize that the trigger 502, 602 as set by the host user is such that a condition evaluation mechanism can be configured with one of a defined set of preconditions, and may present the sidebar 510, 610 to the host user to request that the host user configure the condition evaluation mechanism and select a precondition 512, 612. Configuring the condition evaluation mechanism may include configuring a function and a corresponding value for the condition-frontloaded workflow 500, 600. For example, in FIG. 5, the function may be “order amount greater than threshold” and the threshold may be set by the host user as the value of “5000 USD”. In FIG. 6, the function may be “inventory equal to value” and the value may be set by the host user “0”. Upon configuring the function and the corresponding values, the function and the value may be stored in memory 106 (e.g., in a database in databases 112) in association with the respective condition-frontloaded workflow 500, 600.

In some embodiments, the workflow engine 102 may be aware that the trigger 502, 602 is one that is configurable with a condition evaluation mechanism as a result of a developer of the computer platform having identified the trigger 502, 602 as such. In other embodiments, the workflow engine 102 may ingest the structure or schema of the webhook payload, to determine that the trigger 502, 602 is one that is configurable with a condition evaluation mechanism. In some embodiments, the workflow engine 102 may further, based on the condition set by the host user, automatically set a precondition for the condition evaluation mechanism. For example, with respect to FIG. 6, the workflow engine 102 may recognize that the trigger 602 is one that is configurable with a condition evaluation mechanism, and, based on the condition, set the precondition for the condition evaluation mechanism as the inventory quantity being equal to zero.

In FIGS. 5 and 6, the illustrated precondition 512, 612 was, in addition to being a necessary condition of the condition 504, 604, equal to one of the components of the condition 504, 604. In some embodiments, it may be the case that while the precondition is still a necessary condition, the precondition is not the same as one of the components of the condition. In an example scenario, a host user may build a condition-frontloaded workflow which is triggered by a new order having been created. The condition set by the host user may require that the new order is associated with a new user account that was created in a particular city, e.g., Alameda, California. Instead of setting the precondition as one of the components of the condition (i.e., a new user account was created, or the city defined in the received webhook is Alameda), the precondition may simply be, for example, that the new order is associated with a known user account. If then a new order is associated with a guest checkout instead of a known user account, the precondition evaluates to false and the workflow engine 102 terminates at the condition evaluation mechanism. In this case, while the precondition is still a necessary condition, it is not the same as one of the components of the condition.

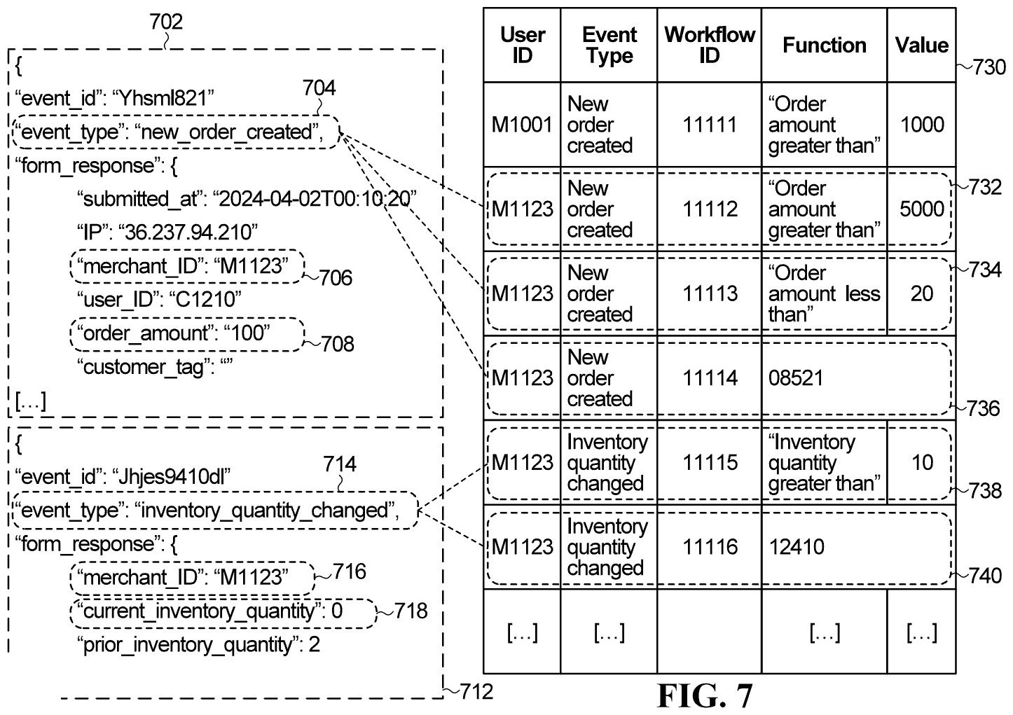

FIG. 7 illustrates example webhook payloads 702, 712 corresponding to triggers 502, 602, respectively, as well as a database 730 that may be used for evaluation of the preconditions 512, 612, according to some embodiments.

Webhook payloads 702, 712 may be in standard JavaScript Object Notation (JSON) format with information represented by key-value pairs, including at least an event type ID element 704, 714, and a nested data object that includes information related to the trigger event that initiated the webhook. For example, for webhook payload 702 which is sent to the workflow engine 102 in response to a new order having been created, the nested data object may include a merchant user ID element 706 and an order amount element 708. For webhook payload 712 which is sent to the workflow engine 102 in response to an inventory quantity change for a product, the nested data object may include a merchant user ID element 716 and a current inventory quantity element 718.

Databases 112 of the workflow engine 102 may include database 730, an event filters database, which may be required to evaluate the preconditions 512, 612. Similar to what has been discussed in relation to FIG. 4, database 730 may allow for the processor 104 of workflow engine 102 to identify, based on data included in the webhook payloads 702 or 712, any relevant workflows, and for any identified relevant workflow, identify whether there is an associated condition evaluation mechanism that includes a precondition represented by a function and a value.

For example, with reference to payload 702, the processor 104 may use the event type ID element 704 of “new_order_created” and the merchant user ID element 706 of “M1123”, to identify three relevant workflows 732, 734, 736, with respective workflow IDs 11112, 11113, and 11114. The three relevant workflows 732, 734, 736 include entries in the “function” and “value” columns of database 730, and thus all three workflows can be identified as condition-frontloaded workflows 732, 734, 736.

In some embodiments, the workflow engine 102 may execute all of the relevant workflows identified using database 730 and the data available in webhook payload 702. For example, the workflow engine 102 may implement the respective condition evaluation mechanism for all three condition-frontloaded workflows 732, 734, 736. Specifically, the precondition of each of the condition-frontloaded workflows may be evaluated. If the precondition evaluates to true, the workflow engine 102 may instruct execution of the associated user-generated logic. If the precondition evaluates to false, the workflow engine 102 may not instruct execution of the associated user-generated logic. For example, condition-frontloaded workflow 732 may correspond to condition-frontloaded workflow 500 of FIG. 5. Using the order amount element 708 of “100” as input to the evaluation function of condition-frontloaded workflow 732, the workflow engine 102 may determine that the precondition 512 evaluates to false, since $100 is less than $5000. Thus, the workflow engine 102 may terminate the execution of the condition-frontloaded workflow 732 (corresponding to condition-frontloaded workflow 500) upon evaluation of the precondition 512, and prior to any execution of the user-generated logic 503. Similarly, using the order amount element 708 of “100”, the workflow engine 102 may determine that the precondition corresponding to workflow 734 is not satisfied, since $100 is greater than $20. Thus, the workflow engine 102 may terminate the execution of the workflow 734 prior to execution of the respective user-generated logic.

Therefore, based on the results of evaluating the precondition 512, 612 of the condition-frontloaded workflow 500, 600, the workflow engine 102 is able to selectively instruct the execution of the user-generated logic 503, 603. When the precondition is satisfied, it is possible for the condition to also be satisfied, and the workflow engine 102 may thus instruct execution of the associated user-generated logic. In cases where the precondition fails to be satisfied, the condition will necessarily also fail to be satisfied, and the workflow engine 102 will not instruct execution of the associated user-generated logic.

With reference to payload 712, the processor 104 may use the event type ID element 714 of “inventory_quantity_changed”, and the merchant user ID element 716 of “M1123”, to identify two relevant workflows 738, 740, with respective workflow IDs 11115 and 11116. The identified relevant workflows 738, 740 both include entries in the “function” and “value” columns of database 730, and thus both workflows can be identified as condition-frontloaded workflows 738, 740.

In some embodiments, the workflow engine 102 may execute all of the relevant workflows identified using database 730 and the data available in webhook payload 712. For example, the workflow engine 102 may implement the respective condition evaluation mechanism for the condition-frontloaded workflows 738, 740. Specifically, the precondition of each of the condition-frontloaded workflows may be evaluated. If the precondition evaluates to true, the workflow engine 102 may instruct execution of the associated user-generated logic. If the precondition evaluates to false, the workflow engine 102 may not instruct execution of the associated user-generated logic. For example, using the current inventory quantity element 718 of “0”, the workflow engine 102 may determine that the precondition corresponding to workflow 738 is not satisfied, since zero is less than 10. Thus, the workflow engine 102 may terminate the execution of the workflow 738 prior to execution of the respective user-generated logic.

In some embodiments, instead of distinct entries for each the “function” and the “value” columns of an event filters database (e.g., database 730) associated with a workflow, there may be a single definition that spans both columns. FIG. 7 illustrates examples with respect to workflows 736 and 740 of database 730. This single definition may be a hash value obtained by hashing a respective parameter name and a value (not shown) of the workflow together. This may be applicable to condition-frontloaded workflows where the precondition can be represented by an equality evaluation function, as opposed to an inequality evaluation function.

For example, the precondition 612 of the condition-frontloaded workflow 600 involves an equality evaluation function (i.e., inventory quantity equal to 0). For such cases the workflow engine 102 may store the evaluation function as a hash value of a parameter name together with the associated value. The parameter name may be set by the workflow engine 102 (or a developer of the computer platform), and may be consistent with a corresponding field element of webhook payloads that are to be received with respect that condition-frontloaded workflow. For example, with respect to condition-frontloaded workflow 600, the workflow engine 102 may be aware that any webhook payload that fires upon occurrence of the trigger 602 will contain current inventory quantity element 718 along with a value that defines the current inventory quantity. Therefore, for precondition 612, the parameter name may be set as “current inventory quantity”. The workflow engine 102 may hash together the parameter name and the associated value of the precondition 612, which is “0”, to arrive at a hash value of “12410” listed with respect to workflow 740 in database 730. When a webhook payload, e.g., payload 712, is received by the workflow engine 102, the workflow engine 102 may hash key-value pairs in the received payload, and compare the hash values against the hash value of “12410”. If there is a match, the associated condition-frontloaded workflow may be identified as a workflow for which the precondition is satisfied, and the user-generated logic should be run. In the case of webhook payload 712, the hash value of the current inventory quantity element 718 would equal “12410”.

An advantage of using hash values may be computer resource efficiency as fewer relevant workflows to execute may be returned when the workflow engine 102 queries an event filters database. For example, without using hash values, both workflows 738 and 740 would be identified as relevant workflows that should be executed. However, when using the hash value implementation, only workflow 740 will be returned as a relevant workflow from the event filters database. In this case, only workflow 740 needs to be executed, and workflow 738 need not be executed at all, i.e., even the precondition of the condition-frontloaded workflow 738 need not be evaluated.

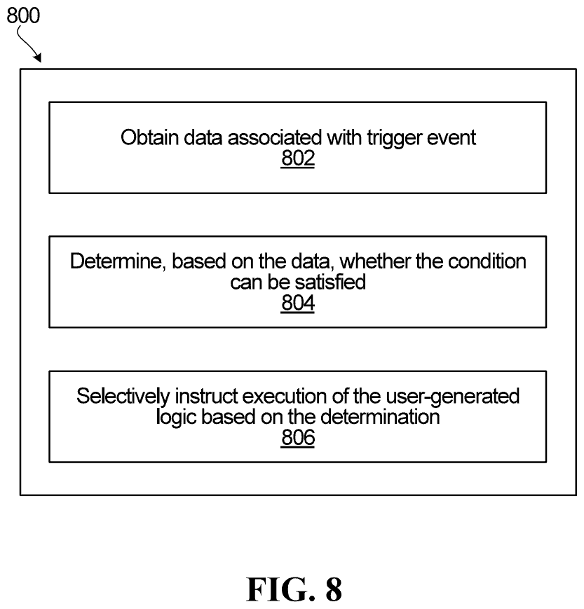

FIG. 8 illustrates a computer-implemented method for selectively instructing execution of a condition-frontloaded computer-implemented automated workflow, according to some embodiments. The method may occur responsive to an occurrence of a trigger event (e.g., trigger 302) associated with initiating the condition-frontloaded workflow. The condition-frontloaded workflow may include user-generated logic (e.g., user-generated logic 303) that includes a condition (e.g. condition 304) and an action (e.g. action 306) to be taken conditioned on whether the condition is satisfied. Prior to execution of the user-generated logic, steps 802, 804 and 806 of the method may be implemented.

At step 802, the processor 104 of the workflow engine 102 may obtain data associated with trigger event. In some embodiments, obtaining the data may include receiving, by the workflow engine 102, an HTTP request, the HTTP request including the data. In some embodiments, the HTTP request may be a webhook. For example, the data obtained may be data included in a webhook that communicates to the workflow engine 102 that the trigger event has occurred.

At step 804, the processor 104 may determine, based on the data, whether the condition can be satisfied. Examples were illustrated with reference to FIGS. 3-7 above. For example, a condition-frontloaded workflow may be configured with a condition evaluation mechanism (e.g., condition evaluation mechanism 311) which includes a precondition that is the same as, or is a necessary condition of, the condition of the condition-frontloaded workflow. Based on data in a webhook payload associated with the condition-frontloaded workflow, the workflow engine 102 may implement the condition evaluation mechanism to determine whether the condition (e.g., condition 304, 504, 604) can be satisfied.

At step 806, the processor 104 may selectively instruct execution of the user-generated logic based on the determination. Selectively instructing execution of the user-generated logic means that the processor 104 will, in some cases, instruct execution of the user-generated logic, while in some other cases, will not instruct execution of the user-generated logic. Whether or not the processor 104 instructs execution of the user-generated logic may be dependent on the determination. In some embodiments, determining based on the data, whether the condition can be satisfied may include determining, based on the data, that the condition can be satisfied, and selectively instructing execution of the user-generated logic may include, responsive to determining that the condition can be satisfied, instructing execution of the user-generated logic. In some embodiments, determining, based on the data, whether the condition can be satisfied may include determining, based on the data, that the condition cannot be satisfied, and selectively instructing execution of the user generated logic may not include instructing execution of the user logic.

For example, based on a determination that the condition can be satisfied (i.e., is at least capable of being satisfied), selectively instructing execution of the user-generated logic may include the processor 104 instructing execution of the user-generated logic. Based on a determination that the condition cannot be satisfied (i.e., is incapable of being satisfied), selectively instructing execution of the user-generated logic may not include the processor 104 instructing execution of the user-generated logic. Embodiments have been described above, with reference to FIGS. 3-7, to provide example scenarios where the processor 104 determines that the condition can be satisfied and therefore instructs execution of the user-generated logic, or the processor 104 determines that the condition cannot be satisfied and therefore does not instruction execution of the user-generated logic. By implementation of a step where the processor 104 determines whether or not the condition can be satisfied prior to any execution of the associated user-generated logic, the processor 104 is given the option to informatively decide whether to instruct execution of the user-generated logic.

In embodiments where there is a determination that the condition can be satisfied, and the workflow engine 102 instructs execution of the user-generated logic, the execution of the user-generated logic may occur in a different context than a context in which the determination as to whether the condition can be satisfied is made. For example, as discussed above, the determination of whether condition can be satisfied is made may be executed within the workflow engine 102, in a resource-efficient manner, while the execution of the user-generated logic may occur external to the workflow engine 102, in a resource-intensive manner. In some embodiments, instructing execution of the user-generated logic includes instructing execution of code corresponding to the user-generated logic, such as machine-executable code 110 stored in memory 106 of the workflow engine 102.

In some embodiments, when the precondition is equal to, or is a necessary condition of, the condition of the condition-frontloaded workflow, the step determining, based on the data, whether the condition can be satisfied may include determining, based on the data, whether the condition is satisfied. For example, when the precondition (e.g., precondition 312) is equal to the condition (e.g., condition 304) of the condition-frontloaded workflow, upon determining that the precondition is satisfied, the condition may also necessarily be satisfied. This is in contrast to scenarios where the precondition (e.g., precondition 512, 612) is a necessary condition of the condition (e.g., condition 504, 604) of the condition-frontloaded workflow such that determining that the precondition is satisfied only ensures that the condition can be, i.e., is capable of being, satisfied, not that it is satisfied as a fact.

In some embodiments, the workflow engine 102 may obtain a value and a function from memory, e.g., from a database stored as part of databases 112 in memory 106. The value and the function may be associated with the condition, and they may together be used to determine whether the condition can be satisfied. For example, in evaluating the precondition 312, 512 or 612, the workflow engine 102 may locate and obtain relevant values and functions from database 420 or 730. The relevant values and functions may be used to determine whether the precondition evaluates to true, and thus whether the condition of the condition-frontloaded workflow can be satisfied.

In some embodiments, the function may be determined based on the condition. For example, the function “order amount greater than” for workflow 732 in FIG. 7 may be determined based on the condition 504 (FIG. 5) of the condition-frontloaded workflow 500 which includes a component that requires an order amount to be greater than a threshold value.

In some embodiments, prior to initiating the condition-frontloaded workflow in response to an occurrence of a trigger event, the workflow engine 102 may receive an indication of the condition-frontloaded workflow. For example, a user device (e.g., device 130) may transmit data to the workflow engine 102 regarding the existence of the condition-frontloaded workflow.

In some embodiments, the processor 104 may transmit to a user device (e.g., host user device 130), web content for display on a graphical user interface of the user device, the web content including the workflow created by a user of the user device (e.g., the content displayed in UI 301, 501, 601 created by a host user of user device 130). The processor 104 may further transmit instructions to update the graphical user interface to permit the user to configure the function and the value (e.g., request for the host user to manually configure the function and the value). The processor 104 may further receive an input via the graphical user interface associated with the user having configured the function and the value, and may store the function and the value in the memory in association with the workflow, as explained above in relation to FIG. 3.

In some embodiments, a workflow identifier assigned to the workflow, a user identifier associated with the workflow, a trigger event identifier associated with the trigger event, the function and the value may be stored in a database in the memory. For example, database 730 illustrates workflow IDs (e.g., 11111, 11112, . . . 11116) assigned to respective workflows, a host user ID (e.g., M1123) associated with each respective workflow, a trigger event identifier associated with the trigger event (e.g., element 704 associated with a new order created), as well as respective function and value entries. The database 730 is stored in memory 106 of the workflow engine 102.

In some embodiments, determining, based on the data, whether the condition can be satisfied may include using a first portion of the data. For example, with respect to FIG. 7, element 708 may be considered to be a first portion of the data (i.e., the data included in webhook payload 702), that is used by the processor 104 to determine whether the condition of a condition-frontloaded workflow can be satisfied. In some embodiments, determining, based on the data, whether the condition can be satisfied may further include querying the database using a second portion of the data associated with the trigger event to locate the workflow identifier, the second portion of the data including the trigger event identifier and the user identifier; using the workflow identifier to retrieve the function and the value; and determining whether the first portion of the data is within a criteria defined by the function and the value to determine whether the condition can be satisfied. For example, with respect to FIG. 7, elements 704, 706 may be respectively considered to be a trigger event identifier and a user identifier that makes up a second portion of the data, that are used to query the database 730 to locate relevant workflow IDs (e.g., workflow ID 11112). As explained in relation to FIG. 7, processor 104 may then use the workflow identifier to retrieve the corresponding function (e.g., “order amount greater than” and value (e.g., “5000”). The workflow engine may determine whether the element 708 is within the criteria defined by the function and the value to determine whether the condition (e.g., condition 504) can be satisfied.

In some embodiments, the value may be a first hash value that includes a hash of: (i) another value associated with the condition and (ii) an identifier associated with the trigger event. For example, the value may be a first hash value obtained by hashing another value and a corresponding parameter name. With respect to FIGS. 6 and 7, for example, the first hash value may be a hash of a parameter name of “current inventory quantity” and the associated value of the precondition 612, which is “0”, to arrive at a hash value of “12410”. Determining, based on the data, whether the condition can be satisfied may include: obtaining a second hash value by hashing (i) the first portion of the data and (ii) an associated identifier of the trigger event in the data; and determining whether the second hash value is equal to the first hash value to determine whether the condition can be satisfied. For example, as seen in FIG. 7, when a webhook payload is received by the workflow engine 102 in response to trigger 602, the processor 104 may hash key-value pairs in the received payload, and compare the hash values against the hash value of “12410”. Any one of the hashed key-value pairs may be considered to be the second hash value, so that if any of the hashed key-value pairs in the webhook payload matches the first hash value, the associated condition-frontloaded workflow may be identified as a workflow for which the precondition is satisfied, and the user-generated logic should be run.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
responsive to an occurrence of a trigger event associated with initiating a computer-implemented automated workflow, the workflow including user-generated logic that includes a condition and an action to be taken conditioned on whether the condition is satisfied, and prior to execution of the user-generated logic:
obtaining data associated with the trigger event;
determining, based on the data, whether the condition can be satisfied; and
selectively instructing execution of the user-generated logic based on the determination.

2. The computer-implemented method of claim 1, wherein:
determining, based on the data, whether the condition can be satisfied includes determining, based on the data, that the condition can be satisfied; and
selectively instructing execution of the user-generated logic includes, responsive to determining that the condition can be satisfied, instructing execution of the user-generated logic.

3. The computer-implemented method of claim 1, wherein:
determining, based on the data, whether the condition can be satisfied includes determining, based on the data, that the condition cannot be satisfied; and
selectively instructing execution of the user generated logic does not include instructing execution of the user logic.

4. The computer-implemented method of claim 1, wherein determining, based on the data, whether the condition can be satisfied includes determining, based on the data, whether the condition is satisfied.

5. The computer-implemented method of claim 2, wherein the user-generated logic executes in a different context than a context in which the determination as to whether the condition can be satisfied is made.

6. The computer-implemented method of claim 2, wherein instructing execution of the user-generated logic includes instructing execution of code corresponding to the user-generated logic.

7. The computer-implemented method of claim 1, further comprising:
prior to initiating the workflow in response to the occurrence of the trigger event:
receiving an indication of the computer-implemented automated workflow.

8. The computer-implemented method of claim 1, further comprising:
obtaining a value and a function from memory, wherein the value and the function are associated with the condition, and wherein the function and the value together are used to determine whether the condition can be satisfied.

9. The computer-implemented method of claim 8, wherein the function is determined based on the condition.

10. The computer-implemented method of claim 8, further comprising:
transmitting, to a user device, web content for display on a graphical user interface of the user device, the web content including the workflow created by a user of the user device;
transmitting, to the user device, instructions to update the graphical user interface to permit the user to configure the function and the value;
receiving, from the user device, an input via the graphical user interface associated with the user having configured the function and the value; and
responsive to receiving the input, storing the function and the value in the memory in association with the workflow.

11. The computer-implemented method of claim 1, wherein obtaining the data comprises receiving a Hypertext Transfer Protocol (HTTP) request, the HTTP request including the data.

12. The computer-implemented method of claim 11, wherein the HTTP request is a webhook.

13. The computer-implemented method of claim 8, wherein a workflow identifier assigned to the workflow, a user identifier associated with the workflow, a trigger event identifier associated with the trigger event, the function and the value are stored in a database in the memory, wherein determining, based on the data, whether the condition can be satisfied comprises using a first portion of the data, and wherein determining, based on the data, whether the condition can be satisfied further comprises:
querying the database using a second portion of the data associated with the trigger event to locate the workflow identifier, the second portion of the data comprising the trigger event identifier and the user identifier;
using the workflow identifier to retrieve the function and the value; and
determining whether the first portion of the data is within a criteria defined by the function and the value to determine whether the condition can be satisfied.

14. The computer-implemented method of claim 13,
wherein the value is a first hash value comprising a hash of: (i) another value associated with the condition and (ii) an identifier associated with the trigger event; and
wherein determining, based on the data, whether the condition can be satisfied comprises:
obtaining a second hash value by hashing (i) the first portion of the data and (ii) an associated identifier of the trigger event in the data; and
determining whether the second hash value is equal to the first hash value to determine whether the condition can be satisfied.

15. A system comprising:
at least one processor; and
a memory storing processor-executable instructions that, when executed, cause the at least one processor to, responsive to an occurrence of a trigger event associated with initiating a computer-implemented automated workflow, the workflow including user-generated logic that includes a condition and an action to be taken conditioned on whether the condition is satisfied, and prior to execution of the user-generated logic:
obtain data associated with the trigger event;
determine, based on the data, whether the condition can be satisfied; and
selectively instruct execution of the user-generated logic based on the determination.

16. The system of claim 15,
wherein the step of determining, based on the data, whether the condition can be satisfied includes determining, based on the data, that the condition can be satisfied; and
wherein the step of selectively instructing execution of the user-generated logic includes, responsive to determining that the condition can be satisfied, instructing execution of the user-generated logic.

17. The system of claim 15,
wherein the step of determining, based on the data, whether the condition can be satisfied includes determining, based on the data, that the condition cannot be satisfied; and
wherein the step of selectively instructing execution of the user-generated logic does not include instructing execution of the user-generated logic.

18. The system of claim 15, wherein the step of determining, based on the data, whether the condition can be satisfied includes determining, based on the data, whether the condition is satisfied.

19. The system of claim 15, wherein the at least one processor is further to:
obtain a value and a function from memory, wherein the value and the function are associated with the condition, and wherein the function and the value together are used to determine whether the condition can be satisfied.

20. The system of claim 19, wherein the at least one processor is further to:
transmit, to a user device, web content for display on a graphical user interface of the user device, the web content including the workflow created by a user of the user device;
transmit, to the user device, instructions to update the graphical user interface to permit the user to configure the function and the value;
receive, from the user device, an input via the graphical user interface associated with the user having configured the function and the value; and
responsive to receiving the input, store the function and the value in the memory in association with the workflow.

21. The system of claim 15, wherein the step of obtaining the data comprises receiving a Hypertext Transfer Protocol (HTTP) request, the HTTP request including the data.

22. The system of claim 19, wherein a workflow identifier assigned to the workflow, a user identifier associated with the workflow, a trigger event identifier associated with the trigger event, the function and the value are stored in a database in the memory, wherein the step of determining, based on the data, whether the condition can be satisfied comprises using a first portion of the data, and wherein the step of determining, based on the data, whether the condition can be satisfied further comprises:
querying the database using a second portion of the data associated with the trigger event to locate the workflow identifier, the second portion of the data comprising the trigger event identifier and the user identifier;
using the workflow identifier to retrieve the function and the value; and
determining whether the first portion of the data is within a criteria defined by the function and the value to determine whether the condition can be satisfied.

23. The system of claim 22, wherein the value is a first hash value comprising a hash of: (i) another value associated with the condition and (ii) an identifier associated with the trigger event; and
wherein the step of determining, based on the data, whether the condition can be satisfied comprises:
obtaining a second hash value by hashing (i) the first portion of the data and (ii) an associated identifier of the trigger event in the data; and
determining whether the second hash value is equal to the first hash value to determine whether the condition can be satisfied.

24. A non-transitory computer readable medium having stored thereon computer-executable instructions that, when executed by a computer, cause the computer to perform operations comprising:
responsive to an occurrence of a trigger event associated with initiating a computer-implemented automated workflow, the workflow including user-generated logic that includes a condition and an action to be taken conditioned on whether the condition is satisfied, and prior to execution of the user-generated logic:
obtaining data associated with the trigger event;
determining, based on the data, whether the condition can be satisfied; and
selectively instructing execution of the user-generated logic based on the determination.
